(19) United States
(12) Patent Application Publication
(10) Pub. No.: US 2007/0012093 A1
(43) Pub. Date: Jan. 18, 2007

(54) Scanning capacitance microscope, method of driving the same, and recording medium storing program for implementing the method

(75) Inventors: Joonhyung Kwon, Gunpo-city (KR); Joonhui Kim, Seoul (KR); Jong-Hwa Jeong, Ulsan-city (KR); Ahram Kim, Seongnam-city (KR); Yong-Seok Kim, Seoul (KR); Sang-il Park, Seongnam-city (KR)

Correspondence Address: SILICON VALLEY PATENT GROUP LLP, 2350 MISSION COLLEGE BOULEVARD, SUITE 360, SANTA CLARA, CA, 95054, US

(73) Assignee: PSIA Co, LTD

(21) Appl. No.: 11/361,505

(22) Filed: Feb. 23, 2006

(30) Foreign Application Priority Data
Jul. 12, 2005 (KR) 10-2005-0062674

(51) Int. Cl. G01B 5/28

(52) U.S. Cl. 73/105

(57) ABSTRACT

Provided are a scanning capacitance microscope, which can be very sensitive to a variation of capacitance between a tip and a sample and can make a clear and accurate measurement by preventing stray capacitance, a method of the scanning capacitance microscope, and a recording medium having embodied thereon a program for the method. The scanning capacitance microscope includes: a resonator including a probe having a cantilever and a tip attached to an end of the cantilever, the resonator resonating according to capacitance between the tip of the probe and a sample; an oscillator generating and applying a signal having a variable frequency to the resonator; and a detector detecting a signal generated by the resonator.

### CROSS-REFERENCE TO RELATED PATENT APPLICATION

This application claims the benefit of Korean Patent Application No. 10-2005-0062674, filed on Jul. 12, 2005, in the Korean Intellectual Property Office, the disclosure of which is incorporated herein in its entirety by reference.

### BACKGROUND OF THE INVENTION

1. Field of the Invention

The present invention relates to a scanning capacitance microscope, a method of driving the same, and a recording medium storing a program for implementing the method, and more particularly, to a scanning capacitance microscope, which is very sensitive to a variation in capacitance between a tip of a probe and a sample and can accurately measure electrical properties by preventing stray capacitance, a method of driving the scanning capacitance microscope, and a recording medium storing a program for implementing the method.

2. Description of the Related Art

Scanning probe microscopes (SPMs) scan a surface of a sample with a probe at nanometer resolution and measure electrical properties of the sample to produce an image. Types of SPMs include an atomic force microscope (AFM), a magnetic force microscope (MFM), and a scanning capacitance microscope (SCM). The present invention particularly relates to SCMs.

SCMs measure capacitance between a tip of a probe and a sample using a resonance frequency which varies according to the tip-sample capacitance. SCMs can measure even a very small amount of capacitance, for example, a capacitance of 10⁻²F using a variation in a resonance frequency. Accordingly, SCMs can be widely used in measuring carrier density of a sample or analyzing a two-dimensional doping profile of a semiconductor sample.

However, conventional SCMs have a drawback in that since an oscillator generates a signal having a fixed frequency, resolution or sensitivity may be degraded when the material of a sample is changed. FIG. 1 is a graph illustrating resonance frequencies measured by a conventional SCM in a case of samples formed of gold on aluminum SA, nikel on steel SB, aluminum oxide SC, silicon SD, and rexolite SE. Referring to FIG. 1, since resonance frequencies vary considerably with the different materials, when an oscillator generates a signal having a fixed frequency, a sample made of a specific material can be measured accurately, but samples made of materials other than the specific material cannot be measured accurately because the sensitivity of the conventional SCM is decreased.

Also, the conventional SCM has a problem in that since stray capacitance, i.e., capacitance between a sample and a carrier supporting a probe as well as the tip-sample capacitance affects measurement results, accurate measurement cannot be ensured. To solve the problem, a method has been suggested to remove a stray capacitance component by modulating a measured signal at a low frequency and measuring dC/dV, that is, a differential of capacitance relative to voltage. However, since this method cannot completely prevent stray capacitance, accurate data without stray capacitance cannot be obtained.

FIG. 2 is a series of images illustrating the tip of the conventional SCM moving over a sample to measure the sample properties. FIG. 3 is a graph illustrating resonance frequencies measured at states A, B, C, and D of FIG. 2. When the conventional SCM is used, a resonance frequency is varied as the probe is moved over the sample, thereby degrading measurement accuracy. This is because the capacitance measured by the conventional SCM includes not only the tip-sample capacitance but also the stray capacitance between the carrier made of metal and the sample. FIG. 4 illustrates a conventional SCM. Referring to FIG. 4, an oscillator 20 applies an electrical signal to a resonator 10 and a detector 30 detects the electrical signal at the resonator 10 via a probe wire 16. In this case, the conventional SCM measures not only capacitance between a tip 12 disposed at an end of a cantilever 11 of a probe 14 and a sample 19 on a mount 18 but also capacitance between a metal carrier 15 and the sample 19, thereby failing to obtain accurate measurement results.

FIG. 5 includes a photograph illustrating a surface of a sample and an image obtained by measuring the sample using the conventional SCM of FIG. 4. The image of the sample is not as clear as the photograph of the sample.

### SUMMARY OF THE INVENTION

According to an aspect of the present invention, there is provided a scanning capacitance microscope comprising: a resonator comprising a probe having a cantilever and a tip attached to an end of the cantilever, the resonator resonating according to capacitance between the tip of the probe and a sample; an oscillator generating and applying a signal having a variable frequency to the resonator; and a detector detecting a signal generated by the resonator.

According to another aspect of the present invention, there is provided a scanning capacitance microscope comprising: a resonator comprising a probe having a cantilever and a tip attached to an end of the cantilever, and a carrier supporting the probe, the resonator resonating according to capacitance between the tip of the probe and a sample; an oscillator generating and applying a signal to the resonator; a detector detecting a signal generated by the resonator; a Z-scanner fixing or moving the probe; and a carrier holder fixing the carrier to the Z-scanner.

The carrier holder may have a clip shape.

At least one of the carrier and the carrier holder may be formed of a non-conductive material.

The non-conductive material may be one of ceramic and a non-conductive polymer.

The non-conductive material may be alumina, polyethereetherketone (PEEK), or Rexolite™.

The scanning capacitance microscope may further comprise an amplifier amplifying the signal generated by the oscillator, wherein the oscillator is electrically connected to a first terminal of the amplifier and the resonator is electrically connected to a second terminal of the amplifier.

The scanning capacitance microscope may further comprise a lock-in amplifier electrically connected to the detector and amplifying the signal detected by the detector.

The scanning capacitance microscope may further comprise an XY scanner moving the sample, and a mount supporting the sample disposed on the XY scanner.

The resonator may further include a shield that prevents radiation of electromagnetic waves from an inside of the resonator.

The oscillator and the detector may be disposed outside the shield.

The shield may be formed of gold on aluminum.

The oscillator may comprise a plurality of oscillators generating signals having variable frequencies in different bands.

According to still another aspect of the present invention, there is provided a method of driving a scanning capacitance microscope, the method comprising: detecting data on a voltage at an output terminal of a resonator corresponding to an overall frequency band by driving an oscillator that generates and applies a signal having a variable frequency to the resonator; representing the data on the voltage at the output terminal of the resonator as a relationship of voltage to frequency; receiving a specific frequency in the band of the variable frequency; and driving the oscillator to generate and apply a signal having the selected specific frequency to the resonator.

The method may further comprise displaying a voltage and a frequency corresponding to a position of a pointer.

The method may further comprise receiving a specific frequency band before the detecting of the data on the voltage at the output terminal of the resonator in the overall frequency band, wherein the detecting of the data on the voltage at the output terminal of the resonator corresponding to the overall frequency band comprises detecting data on a voltage corresponding to the selected specific frequency band at the output terminal of a resonator by driving the oscillator that generates and applies a signal having a variable frequency to the resonator, and the receiving of the specific frequency comprises receiving a specific frequency in the selected specific frequency band.

The method may further comprise determining whether a peak voltage exits between the representing of the data on the voltage at the output terminal of the resonator as the relationship of frequency to voltage and the receiving of the specific frequency, wherein if it is determined that a peak voltage exits, the method proceeds to the receiving of the specific frequency, and if it is determined that a peak voltage does not exist, the method returns to the receiving of the specific frequency band to receive a new specific band different from the previous band.

Before the detecting of the data on the voltage at the output terminal of the resonator, the method may further comprise: receiving data on an area of a sample to be analyzed; and outputting the area data to an actuator that changes a position of a probe relative to the sample.

According to yet another aspect of the present invention, there is provided a computer-readable recording medium having embodied thereon a program for the method of claim 18.

### BRIEF DESCRIPTION OF THE DRAWINGS

The above and other features and advantages of the present invention will become more apparent by describing in detail exemplary embodiments thereof with reference to the attached drawings in which:

FIG. 1 is a graph illustrating resonance frequencies measured by a conventional scanning capacitance microscope (SCM) in a case of samples formed of different materials;

FIG. 2 is a series of images illustrating properties of a tip of the conventional SCM moving over a sample to measure the sample properties;

FIG. 3 is a graph illustrating resonance frequencies measured at states of FIG. 2;

FIG. 4 illustrates a conventional SCM wherein stray capacitance is generated;

FIG. 5 includes a photograph illustrating a surface of a sample and an image obtained by measuring the sample using the conventional SCM of FIG. 4;

FIG. 6 illustrates an SCM according to an embodiment of the present invention;

FIG. 7 is a graph for explaining a process of obtaining a resonance frequency by varying a frequency of a signal oscillated by an oscillator of the SCM of FIG. 6;

FIG. 8 is a flowchart illustrating a method of driving an SCM according to an embodiment of the present invention;

FIG. 9 is a flowchart illustrating a method of driving an SCM according to another embodiment of the present invention;

FIG. 10 is a perspective view of a probe of an SCM and a carrier supporting the probe according to another embodiment of the present invention;

FIG. 11 is a perspective view of a carrier holder fixing the carrier of FIG. 10;

FIG. 12 is a perspective view of a resonator shield of an SCM according to another embodiment of the present invention; and

FIG. 13 includes a photograph illustrating a surface of a sample and an image obtained by measuring the sample using the SCM of the present invention.

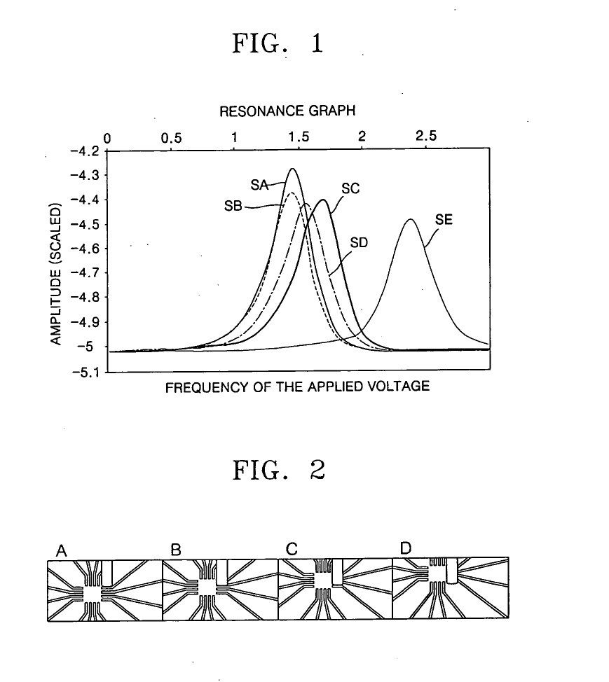

### DETAILED DESCRIPTION OF THE INVENTION

The present invention will now be described more fully with reference to the accompanying drawings, in which preferred embodiments of the invention are shown.

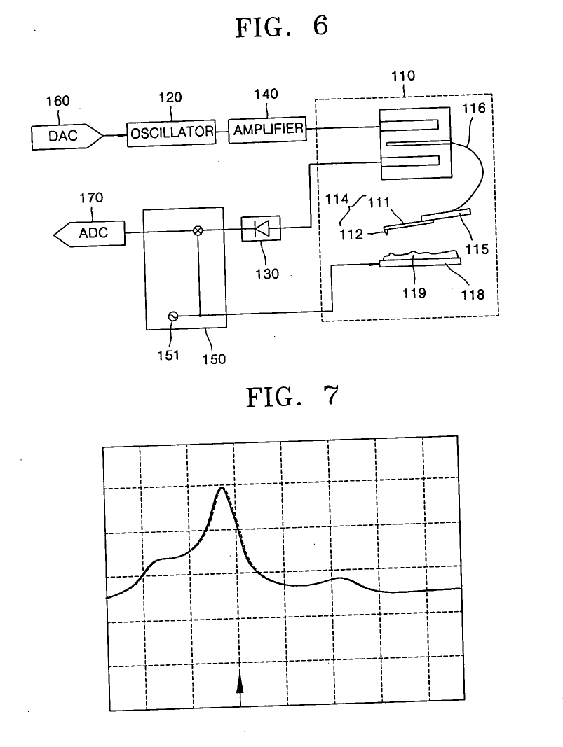

FIG. 6 illustrates a scanning capacitance microscope (SCM) according to an embodiment of the present invention.

Referring to FIG. 6, the SCM includes a resonator 110. The resonator 110 includes a probe 114 having a cantilever 111 and a tip 112 attached to an end of the cantilever 111. The resonator 110 resonates according to capacitance between the tip 112 of the probe 114 and a sample 119. The probe 114 may be coated with a conductive material, for example, CrAu or TiPt. A probe wire 116 is connected to the probe 114 to transmit an electrical signal to the probe 114. The probe 114 may be supported by a carrier 115. An oscillator 120 is connected to an end of the resonator 110. The oscillator 120 generates and applies a signal having a variable frequency to the resonator 110. If required, an amplifier 140, which amplifies the signal generated by the oscillator 120, may be interposed between the oscillator 120 and the resonator 110 as illustrated in FIG. 6. In this case, the oscillator 120 is electrically connected to a first terminal of the amplifier 140 and the resonator 110 is electrically connected to a second terminal of the amplifier 140. The SCM of the present embodiment includes a detector 130 detecting a signal generated at the resonator 110. The SCM may further include a lock-in amplifier 150 that amplifies the signal detected by the detector 130. The lock-in amplifier 150 may include means 151 for removing a stray capacitance component by modulating a signal at a low frequency and measuring dC/dV, that is, a differential of capacitance relative to voltage.

The SCM of FIG. 6 can collect data on the properties of the sample 119 by scanning the sample 119 using the probe 114 to measure carrier density of the sample 119 or analyze a two-dimensional doping profile of the semiconductor sample 119. That is, when a bottom surface of the sample 119 disposed on a mount 118 is coated with a conductive material, the two conductors, that is, the bottom surface of the sample 119 and the tip 112 of the probe 114 become equivalent capacitors with a dielectric, i.e., the sample 119, therebetween. The properties of the sample 119 can be analyzed by measuring capacitance between the equivalent capacitors. In this case, the sample 119 having the bottom surface coated with the conductive material may be fixed to the mount 118 using a magnet. However, the present invention is not limited thereto. For example, the sample 119 may be fixed to the mount 118 using a conductive adhesive. Likewise, various modifications can be made in embodiments which will be explained later.

The SCM of FIG. 6 may further include an element for adjusting relative positions of the sample 119 and the probe 114. The element may be able to move only the probe 114, only the sample 119, or both the probe 114 and the sample 119. Various modifications can be made in this way, and also in embodiments to be explained later.

A conventional SCM has a disadvantage in that since an oscillator generates a signal having a fixed frequency, the resolution or sensitivity of the conventional SCM may be degraded according to the material of a sample. However, according to the SCM of the present embodiment, since the oscillator 120 generates and applies a signal having a variable frequency to the resonator 110, degradation in resolution or sensitivity can be avoided when the material of the sample 119 is changed.

FIG. 7 is a graph for explaining a process of obtaining a resonance frequency by varying the frequency of the signal oscillated by the oscillator 120 of the SCM of FIG. 6. In detail, the process of obtaining a resonance frequency includes varying the frequency of the signal generated by the oscillator 120 to detect a signal, e.g., a voltage, at an output terminal of the resonator 110, representing the detected voltage as a frequency graph, and finding the resonance frequency.

Accordingly, a more accurate and clear image can be achieved by applying a signal to the sample 119 having a frequency suitable for the sample 119. In the frequency graph, a variation in the detected signal according to a variation in the applied frequency is greatest at a point where the inclination of the tangent line is greatest. Accordingly, a more accurate and clearer image can be obtained by detecting a resonance frequency suitable for the sample 119, applying a frequency at an amplitude of about half of the maximum amplitude as indicated by an arrow in FIG. 7 to the resonator 110, and scanning the surface of the sample 119 to detect data.

The oscillator 120 may be a voltage-controlled oscillator (VCO) which can output a desired oscillation frequency according to an external voltage.

In this case, the SCM may further include a digital-to-analog converter (DAC) 160 to adjust the frequency of the signal generated by the oscillator 120, and an analog-to-digital converter (ADC) 170 to obtain data of the sample 119 based on the signal detected by the detector 130, as illustrated in FIG. 6.

The oscillator 120 may include a plurality of oscillators generating signals having variable frequencies in different bands. That is, the oscillator 120 may include a first oscillator generating a signal having a variable frequency in a first band, and a second oscillator generating a signal having a variable frequency in a second band different from the first band. In this case, signals having a variety of frequencies can be used, and thus more accurate data can be detected from the sample 119.

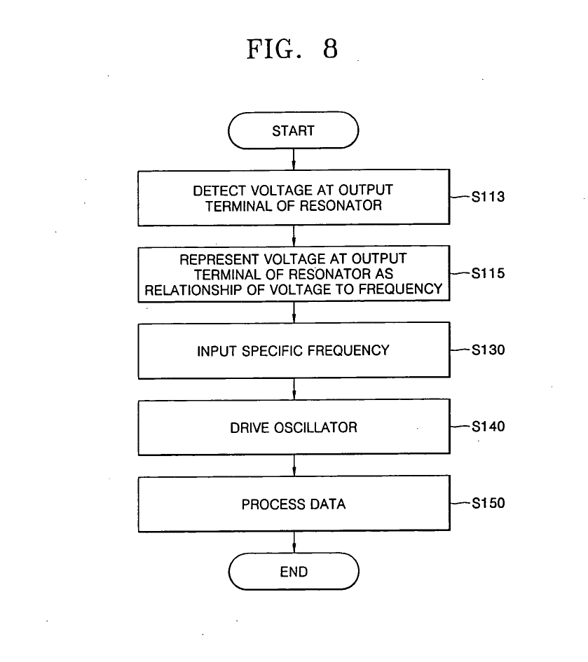

FIG. 8 is a flowchart illustrating a method of driving an SCM according to an embodiment of the present invention.

In operation S113, a voltage at an output terminal of a resonator is detected as described above by driving an oscillator, which generates and applies a signal having a variable frequency to the resonator, such that the voltage at the output terminal of the resonator can be detected over the band of the frequency generated by the oscillator. Although the voltage is used as a detected signal in this embodiment, other electrical signal such as a current may be used as the detected signal.

In operation S115, data on the voltage at the output terminal of the resonator is represented as a relationship of frequency to voltage so that a user can determine at which frequency a variation in the voltage at the output terminal of the resonator is greatest. For example, the relationship of frequency to voltage may be represented as the graph illustrated in FIG. 7.

In operation S130, a specific frequency in the band of the variable frequency is received from the user. For example, the user may designate the position of the arrow of FIG. 7 using a computer and a mouse pointer connected to the computer. For user convenience, a voltage and a frequency corresponding to the position of the pointer may be displayed. The specific frequency received from the user may be the frequency at or around which the variation in the voltage is greatest, that is, the inclination is greatest as described above.

In operation S140, the oscillator is driven to generate and apply a signal having the selected specific frequency to the resonator. In operation S150, data on the sample obtained in the above operations is processed.

Before obtaining the data on the voltage at the output terminal of the resonator, an area of the sample to be analyzed may be set and the position of the area of the sample to be analyzed may be adjusted. That is, after data on the area of the sample to be analyzed is received and the data on the area is output to an actuator that changes the position of the probe relative to the sample, the method may proceed to operation S113 in which the voltage between the tip and the sample is detected.

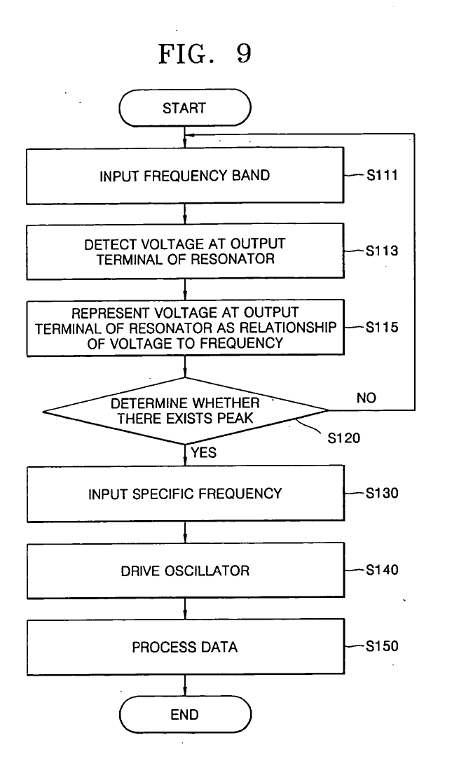

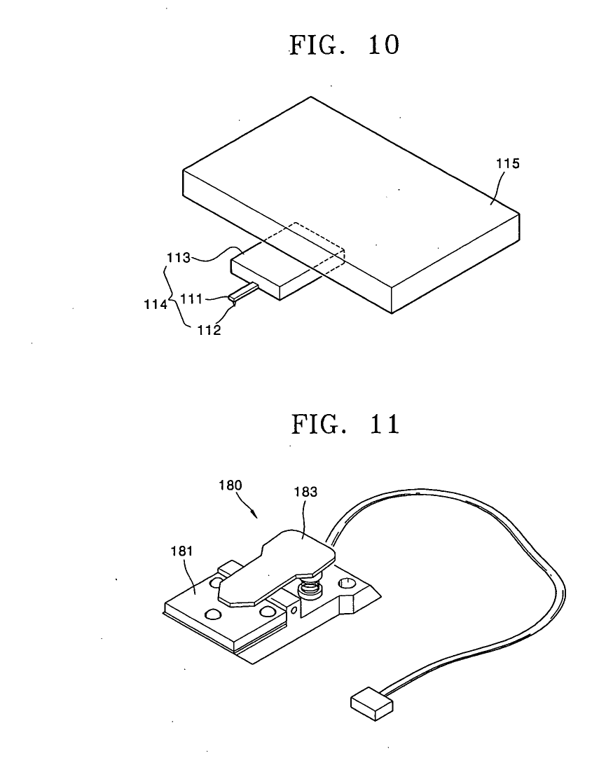

FIG. 9 is a flowchart illustrating a method of driving an SCM according to another embodiment of the present invention.

An oscillator may include a plurality of oscillators that generate signals having variable frequencies in different bands as described above. In this case, operation S111 in which a specific frequency band is received is performed before operation S113 in which a voltage at an output terminal of a resonator is detected. For example, when the oscillator includes first, second, and third oscillators generating signals having variable frequencies in different bands, one of the three oscillators is selected in operation S111 . Next, in operation S113, a voltage at an output terminal of the resonator in the selected specific frequency band is detected. In operation S115, data on the voltage at the output terminal of the resonator is represented as a relationship of frequency to voltage.

Next, in operation S120, it is determined whether there exists a peak voltage. The peak voltage is the highest voltage as illustrated in FIG. 7, at which the resonator resonates.

If it is determined in operation S120 that a peak voltage exists as illustrated in FIG. 7, the method proceeds to operation S130. In operation S130, a specific frequency is received.

However, if it is determined that a peak voltage does not exist in operation S120, the method returns to operation S111. In operation S111, a new specific frequency band, which is different from the previous specific frequency, is received. For example, if the first oscillator among the first, second, and third oscillators is initially selected, the second or third oscillator will be selected later. After the new specific frequency band is received, the operations for obtaining a peak voltage are repeated.

According to the present embodiment, when the oscillator includes the first, second, and third oscillators generating signals having variable frequencies in different bands, one of the oscillators is selected in operation S111 to receive a specific frequency band. However, the present invention is not limited thereto. For example, one oscillator generating a signal having a variable frequency may be provided, and a part of the band of frequencies generated by the oscillator may be received.

The method of driving the SCM according to the present embodiment can be executed as a computer program. Codes and code segments that perform the program can be easily inferred by a computer programmer skilled in this field. Also, the program can be stored in a computer readable information storage medium, and read and executed by a computer to drive the SCM. The information storage medium or recording medium may be a magnetic recording medium, an optical recording medium, or a carrier wave medium.

FIG. 10 is a perspective view of a probe of an SCM and a carrier supporting the probe according to another embodiment of the present invention. FIG. 11 is a plan view of a carrier holder fixing a carrier of FIG. 10.

The SCM illustrated in FIGS. 10 and 11 has a similar configuration as the SCM illustrated in FIGS. 6 and 7. That is, the SCM of FIGS. 10 and 11 includes a resonator. The resonator includes a probe 114 and a carrier 115 supporting the probe 114. The probe 114 has a cantilever 111 and a tip 112 attached to an end of the cantilever 111. The probe 114 in FIG. 10 is exaggerated for ease of understanding. The probe 114 is typically provided in the form of a semiconductor chip 113. In general, the semiconductor chip 113 has a width of 1.6 mm and a length of 3.6 mm. The cantilever 111 has a length of approximately 100 μm and projects from an edge of the semiconductor chip 113. The tip 112 is attached to the end of the cantilever 111. The probe 114 includes the semiconductor chip 113, the cantilever 111, and the tip 112 according to the present embodiment. Since the probe 114 is so small, it is attached to the carrier 115 for the purpose of easy handling. There are various methods of attaching the probe 114 to the carrier 115. For example, the probe 114 may be attached to the carrier 115 using an adhesive.

The resonator resonates according to capacitance between the tip 112 of the probe 114 and a sample. The SCM of the present embodiment includes an oscillator and a detector. The oscillator applies a signal having a frequency to the resonator, and the detector detects a signal generated by the resonator.

A Z-scanner fixes or moves the probe 114. That is, as described above with reference to FIGS. 6 and 7, when the SCM of FIGS. 10 and 11 scans the sample using the probe 114 and collects data on properties of the sample by measuring carrier density of the sample or analyzing a two-dimensional doping profile of the semiconductor sample. Only the probe 114 may be moved horizontally and vertically, only the sample may be moved horizontally and vertically, or both the probe 114 and the sample may be moved horizontally and vertically. When only the probe 114 is moved, the Z-scanner of the SCM of FIGS. 10 and 11 moves the probe 114 horizontally and vertically (not limited to movement along a Z-axis). When only the sample is moved, the Z-scanner fixes the probe 114 to a predetermined position. When the probe 114 is moved vertically and the sample is moved horizontally (along the XY plane), the Z-scanner moves the probe 114 along the Z-axis. The relative positions of the probe 114 and the sample may be changed in other ways. Accordingly, the movement and direction of the probe 114 is not limited by the type of a Z-scanner used.

As described above, the SCM of FIGS. 10 and 11 obtains data on the properties of the sample by measuring the tip-sample capacitance. In this case, the detected data should include only the tip-sample capacitance with no stray capacitance. A conventional SCM includes a metal carrier attached to a Z-scanner using a magnet mounted on the Z-scanner. Accordingly, the conventional SCM has a disadvantage in that not only tip-sample capacitance but also stray capacitance, that is, capacitance between the carrier supporting the probe and the sample affect measurement results, making it difficult to achieve an accurate measurement. To solve the problem, stray capacitance can be removed by modulating a measured signal at a low frequency and measuring dC/dV, that is, a differential of capacitance relative to voltage. However, this cannot completely prevent stray capacitance, and thus accurate data without stray capacitance cannot be obtained. However, the SCM according to the present embodiment includes the carrier 115 which is formed of a non-conductive material, for example, ceramic or a non-conductive polymer. Accordingly, stray capacitance is prevented from being generated, thereby making it possible to collect more accurate data. In this case, the ceramic may include alumina, and the non-conductive polymer may include engineering plastic, for example, polyethereetherketone (PEEK) or Rexolite . Other non-conductive materials may also be used. Measurement accuracy may be further increased by modulating a measured signal at a low frequency and measuring dC/dV, as well as by using the carrier 115 formed of non-conductive material.

While the carrier of the conventional SCM is formed of metal and is fixed to the Z-scanner using the magnet, the SCM according to the present embodiment needs a carrier holder to fix the carrier 115 to the Z-scanner because the carrier 115 is formed of non-conductive material. FIG. 11 is a perspective view of a carrier holder 180. Referring to FIG. 11, the carrier holder 180 has a clip shape, and includes a portion 181 to which the carrier 115 is attached and lever means 183 formed of an elastic material, such as a spring, to help the carrier 115 to be easily attached to and detached from the portion 181.

The carrier holder 180 may be formed of metal, or a non-conductive material, such as ceramic or non-conductive polymer including alumina, PEEK, or Rexolite™. The carrier holder 180 may be formed of other non-conductive material.

Since the carrier of the conventional SCM is formed of metal and fixed to the Z-scanner using the magnet, a magnetic field generated (by the magnet may affect a detected signal. Accordingly, when the carrier 115 according to the present embodiment is formed of metal, the carrier 115 may be fixed to the Z-scanner using the carrier holder 180. In this case, the carrier holder 180 may be formed of metal or a non-conductive material.

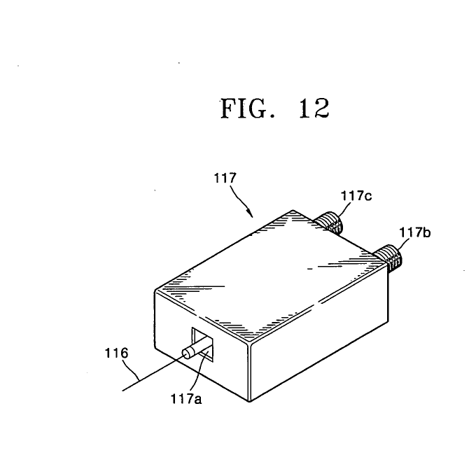

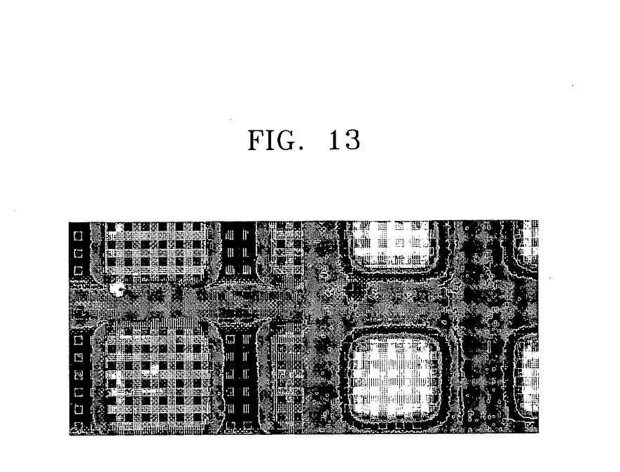

FIG. 12 is a perspective view of a resonator shield of an SCM according to another embodiment of the present invention.

Referring to FIG. 12, elements except a probe of a resonator and a sample are shielded by a shield 117. The shield 117 includes an input unit 117b inputting a signal to the resonator, a signal output unit 117c outputting a signal to a detector, and an aperture 117a through which a probe wire 116 connected to a probe of the resonator is exposed.

As described above, since the ultimate purpose of the SCM according to the present embodiment is to detect tip-sample capacitance, electromagnetic waves, which may affect the measurement of the capacitance, should be removed. Accordingly, the shield 117 shields all the elements except the probe of the resonator and the sample to prevent electromagnetic waves generated by the elements from affecting the measurement results. In this case, to maximize the electromagnetic wave shielding effect, the shield 117 may be formed of gold-on-aluminium. Of course, the shield 117 may be formed of other materials.

In this case, an oscillator and the detector may be disposed outside the shield 117. Quality factors, which should be considered in the design of the resonator, are determined by the internal design of the resonator. The oscillator and the detector may be disposed inside the shield 117 but, in this case, the quality factors of the resonator may be degraded due to the oscillator and the detector. Accordingly, the oscillator and the detector may be disposed outside the shield 117.

In the previous embodiments of the present invention, when optical elements are further included to measure a bending degree of the cantilever according to an attractive force or a repulsive force between the cantilever and the sample, the SCM may act as an atomic force microscope (AFM) as well. In this case, the SCM can measure data on the properties of the sample and observe the surface shape of the sample.

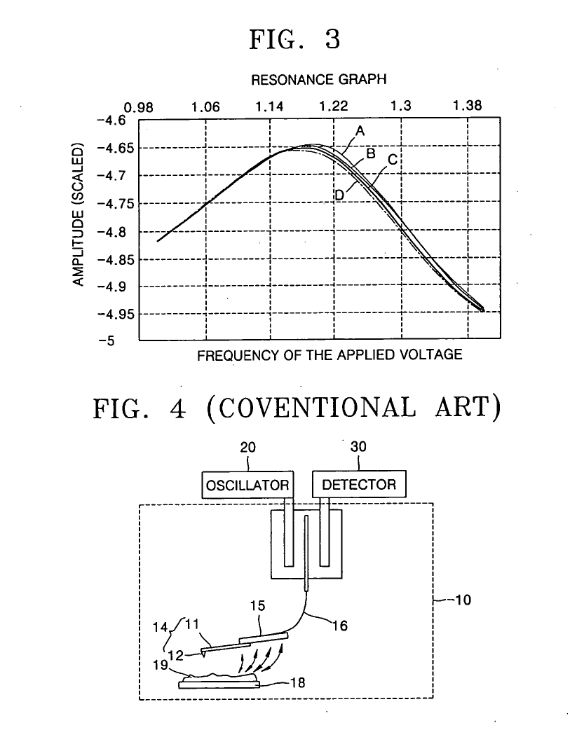

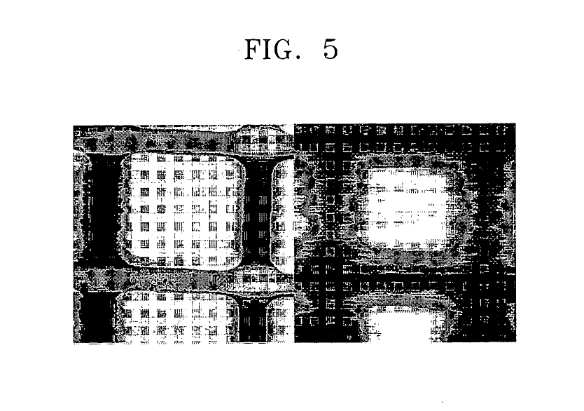

The SCM including the oscillator generating a signal having a variable frequency, the SCM having the carrier holder, and the SCM having the shield that shields a part of the resonator have been described in the previous embodiments. An SCM having all those features may measure more accurate data. FIG. 13 includes a photograph illustrating a surface of a sample and an image measured by the SCM of the present invention. The image measured by the SCM of the present invention illustrated in FIG. 3 is clearer than an image measured by a conventional SCM illustrated in FIG. 5,

As described above, the SCM, the method of driving the SCM, and the recording medium having embodied thereon a program for the method according to the present invention have the following advantages.

First, since the SCM includes the oscillator generating a signal having a variable frequency, the SCM can be very sensitive to the properties of the sample irrespective of the material of the sample, and thus can obtain more accurate data on the sample.

Second, since the SCM includes the carrier holder, the carrier can be fixed to the Z-scanner without a magnet, and the effect of a magnetic field can be avoided.

Third, since the SCM includes a carrier formed of a non-conductive material, the SCM can prevent stray capacitance, and can obtain more accurate data on the sample.

Fourth, since the SCM includes the shield that shields elements other than the probe and the sample, the SCM can obtain more accurate data on the sample.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A scanning capacitance microscope comprising:
a resonator comprising a probe having a cantilever and a tip attached to an end of the cantilever, the resonator resonating according to capacitance between the tip of the probe and a sample;
an oscillator generating and applying a signal having a variable frequency to the resonator; and
a detector detecting a signal generated by the resonator.

2. The scanning capacitance microscope of claim 1, further comprising an amplifier amplifying the signal generated by the oscillator,
wherein the oscillator is electrically connected to a first terminal of the amplifier and the resonator is electrically connected to a second terminal of the amplifier.

3. The scanning capacitance microscope of claim 1, further comprising a lock-on amplifier electrically connected to the detector and amplifying the signal detected by the detector.

4. The scanning capacitance microscope of claim 1, wherein the resonator further comprises a shield that prevents radiation of electromagnetic waves from the inside of the resonator.

5. The scanning capacitance microscope of claim 4, wherein the oscillator and the detector are disposed outside the shield.

6. The scanning capacitance microscope of claim 4, wherein the shield is formed of gold on aluminum.

7. The scanning capacitance microscope of claim 1, wherein the oscillator comprises a plurality of oscillators generating signals having variable frequencies in different bands.

8. A scanning capacitance microscope comprising:
a resonator comprising a probe having a cantilever and a tip attached to an end of the cantilever, and a carrier supporting the probe, the resonator resonating according to capacitance between the tip of the probe and a sample;
an oscillator generating and applying a signal to the resonator;
a detector detecting a signal generated by the resonator;
a Z-scanner fixing or moving the probe; and
a carrier holder fixing the carrier to the Z-scanner.

9. The scanning capacitance microscope of claim 8, wherein the carrier holder has a clip shape.

10. The scanning capacitance microscope of claim 8, wherein at least one of the carrier and the carrier holder is formed of a non-conductive material.

11. The scanning capacitance microscope of claim 8, wherein the non-conductive material is one of ceramic and a non-conductive polymer.

12. The scanning capacitance microscope of claim 11, wherein the non-conductive material is alumina, polyethereetherketone (PEEK), or Rexolite™.

13. The scanning capacitance microscope of claim 8, further comprising an amplifier amplifying the signal generated by the oscillator,
wherein the oscillator is electrically connected to a first terminal of the amplifier and the resonator is electrically connected to a second terminal of the amplifier.

14. The scanning capacitance microscope of claim 8, further comprising a lock-in amplifier electrically connected to the detector and amplifying the signal detected by the detector.

15. The scanning capacitance microscope of claim 5, wherein the resonator further includes a shield that prevents radiation of electromagnetic waves from an inside of the resonator.

16. The scanning capacitance microscope of claim 15, wherein the oscillator and the detector are disposed outside the shield.

17. The scanning capacitance microscope of claim 15, wherein the shield is formed of gold on aluminum.

18. A method of driving a scanning capacitance microscope, the method comprising:
detecting data on a voltage at an output terminal of a resonator corresponding to an overall frequency band by driving an oscillator that generates and applies a signal having a variable frequency to the resonator;
representing the data on the voltage at the output terminal of the resonator as a relationship of voltage to frequency;
receiving a specific frequency in the band of the variable frequency; and
driving the oscillator to generate and apply a signal having the selected specific frequency to the resonator.

19. The method of claim 18, further comprising displaying a voltage and a frequency corresponding to a position of a pointer.

20. The method of claim 18, further comprising receiving a specific frequency band before the detecting of the data on the voltage at the output terminal of the resonator corresponding to the overall frequency band,
wherein the detecting of the data on the voltage at the output terminal of the resonator in the overall frequency band comprises detecting data on a voltage corresponding to the selected specific frequency band at the output terminal of the resonator by driving the oscillator that generates and applies a signal having a variable frequency to the resonator, and the receiving of the specific frequency comprises receiving a specific frequency in the selected specific frequency band.

21. The method of claim 20, further comprising determining whether a peak voltage exists between the representing of the data on the voltage at the output terminal of the resonator as the relationship of frequency to voltage and the receiving of the specific frequency,
wherein if it is determined that a peak voltage exists, the method proceeds to the receiving of the specific frequency, and if it is determined that a peak voltage does not exist, the method returns to the receiving of the specific frequency band to receive a new specific band different from the previous band.

22. The method of claim 18, before the detecting of the data on the voltage at the output terminal of the resonator, the method further comprising:
receiving data on an area of a sample to be analyzed; and
outputting the area data to an actuator that changes a position of a probe relative to the sample.

23. A computer-readable recording medium having embodied thereon a program for the method of claim 18.
